(19) United States
(12) Patent Application Publication
(10) Pub. No.: US 2015/0204520 A1
(43) Pub. Date: Jul. 23, 2015

(54) Indirect Dome Light

(71) Applicants: Dennis Pearson, Foothill Ranch, CA (US); Michael D. Bremser, Seal Beach, CA (US); Guang Jin, Santa Monica, CA (US)

(72) Inventors: Dennis Pearson, Foothill Ranch, CA (US); Michael D. Bremser, Seal Beach, CA (US); Guang Jin, Santa Monica, CA (US)

(21) Appl. No.: 14/160,410

(22) Filed: Jan. 21, 2014

(51) Int. Cl. F21V 17/12; F21K 99/00; F21S 8/06; F21V 29/00

(52) U.S. Cl. CPC F21V 17/12; F21V 29/22; F21V 29/2231; F21K 9/50; F21S 8/06

(57) ABSTRACT

An indirect LED light engine including a printed circuit board mounting one or more LEDs, a dome-shaped heat sink component having an internal mounting structure for mounting the printed circuit board, a heat conductive hollow metal tube attached to the heat sink component, and a lens component mounted over the one or more LEDs. Such a light engine may be positioned within a lamp shade by attaching the metal tube to a junction box disposed within the lamp shade to create, for example, a pendant light wherein an undersurface of the junction box is adapted to receive light transmitted from the LEDs and to reflect that light in a desired manner.

### BACKGROUND

1. Field

The subject disclosure relates to electric lighting fixtures and more particularly to such fixtures employing an indirect LED light engine featuring a dome-shaped heat sink.

2. Related Art

Lamps or light fixtures have been provided in the prior art which employ an Edison-type incandescent bulb or other traditional light source with a socket positioned within a surrounding lamp shade.

### SUMMARY

An indirect LED light engine according to an illustrative embodiment may comprise a printed circuit board mounting one or more LEDs, a dome-shaped heat sink component having an internal mounting structure for mounting the printed circuit board, the mounting structure having a central opening therein, a heat conductive tube mounted in the central opening, and a lens component mounted over the one or more LEDs and having an opening therein through which the heat conductive tube protrudes. Such a light engine may be located within a lamp shade to create, for example, a pendant light. In one such embodiment, the light engine is suspended from a junction box located within the lamp shade, and an undersurface of the junction box is adapted to receive light transmitted from the LEDs and to reflect all or a portion of that light in a desired or selected manner.

### BRIEF DESCRIPTION OF THE DRAWINGS

FIG. 1 is a side view of an indirect LED light engine according to an illustrative embodiment;

FIG. 2 is a top view of the light engine of FIG. 1;

FIG. 3 is a bottom view of the light engine of FIG. 1;

FIG. 4 is an exploded perspective view of the light engine of FIG. 1;

FIG. 5 is a side view of an illustrative pendent light embodiment;

FIG. 6 is a sectional view of an illustrative pendent light embodiment taken at VI-VI of FIG. 5;

FIG. 7 is an exploded perspective view of componentry of the pendent light embodiment of FIG. 5; and

FIG. 8 is a perspective view of a lamp shade component of the pendent light embodiment of FIG. 5.

FIG. 9 is a partial perspective view of the pendent light embodiment of FIG. 5;

FIG. 10 is a second partial perspective view of the pendent light embodiment of FIG. 5;

FIG. 11 is a side view of the pendent light embodiment of FIG. 5 with a junction box component thereof shown in a disassembled state;

FIG. 12 is a schematic diagram illustrating the light reflection path in the illustrative pendent light embodiment.

### DETAILED DESCRIPTION

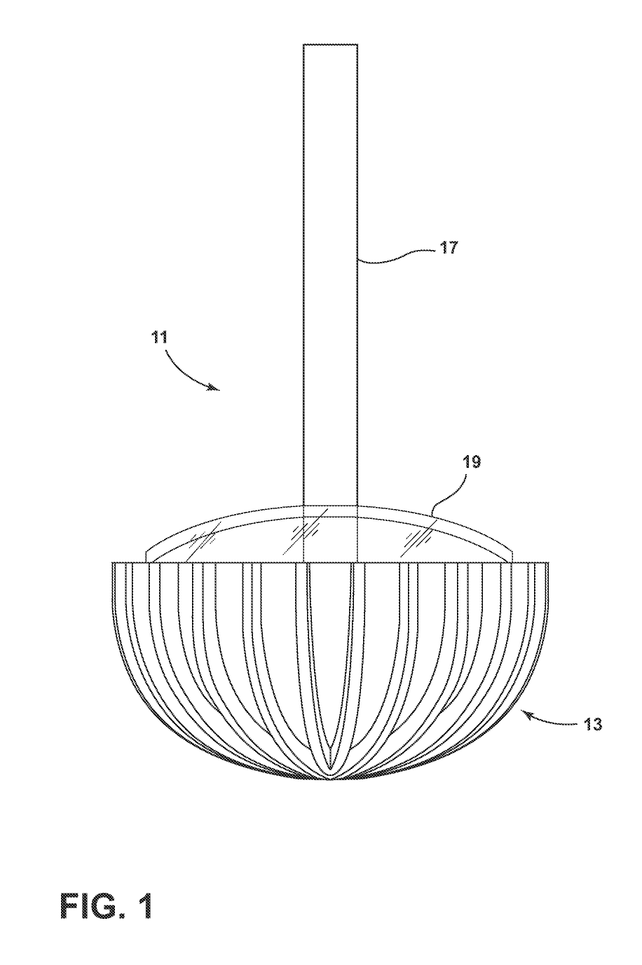

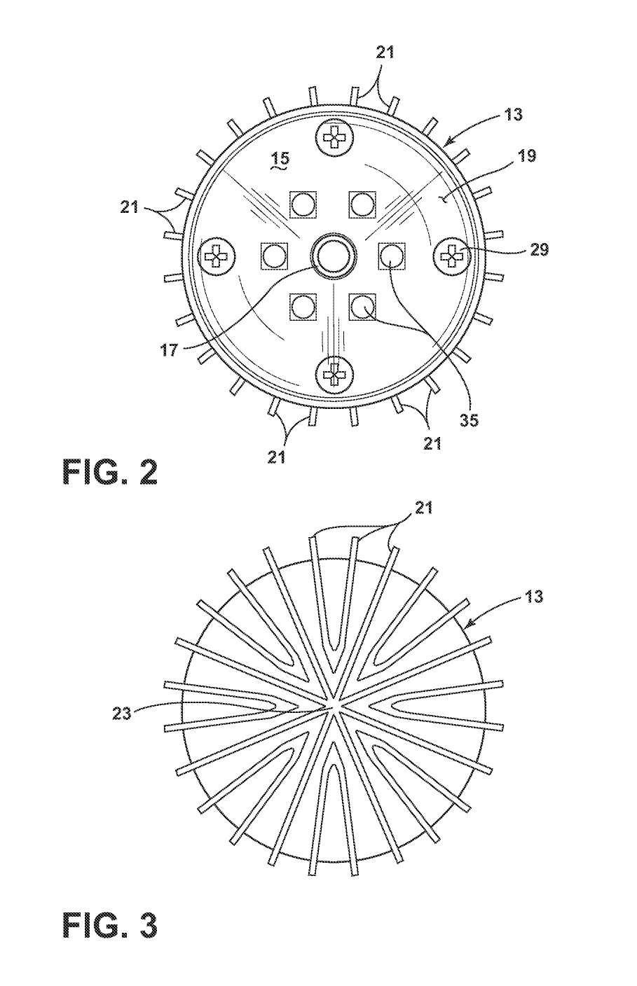

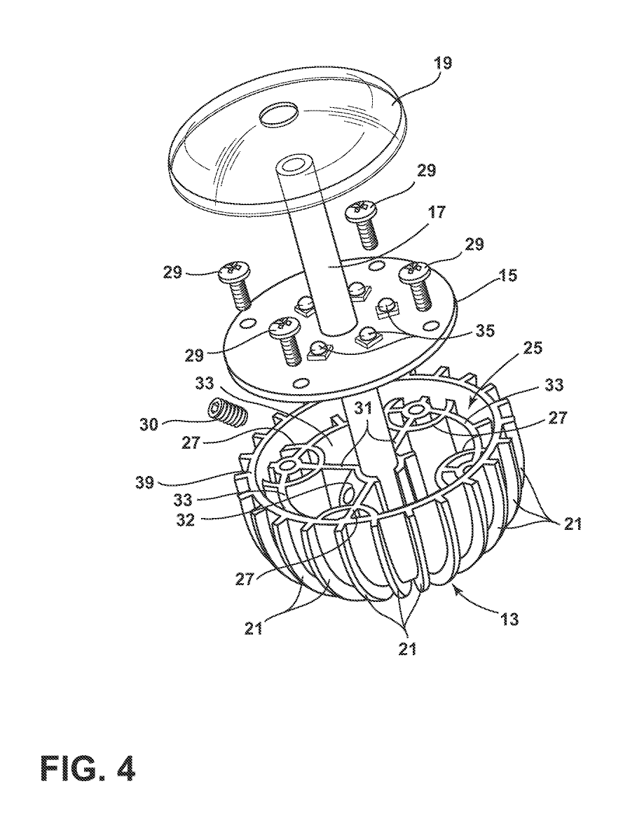

FIGS. 1-4 show an illustrative embodiment of an indirect light engine 11, which includes a dome-shaped heat sink 13, an LED printed circuit board (PCB) 15, an aluminum tube 17 and a lens 19.

The PCB 15 provides a mounting surface or mounting board for one or more LEDs 35 and attendant electrical circuitry such that, in one embodiment, the LED light is directed upwardly. In one embodiment, the top surface of the PCB 15 lies just below the top rim 39 of the heat sink 13. In one embodiment, the PCB may be FR4 material, but may be other materials, for example, metal clad to better facilitate heat transfer.

In one embodiment, the dome-shaped heat sink 13 may be a single or unitary part or component formed of die cast aluminum alloy such as A380 alloy or other suitable material and includes a number of curved external heat sink fins, e.g., 21 disposed adjacent one another and running generally vertically downward and then curving in towards a central area 23 at the bottom of the dome 13. The interior 25 of the dome-shaped heat sink 13 includes four vertically disposed bosses 27 for threadably receiving respective screws 29, which attach the PCB 15 to the heat sink 13. Radial ribs 31 and circumferential ribs 33 unitarily formed with the four bosses 27 provide a web structure which adds support to the four bosses 27 and which assists in conducting heat generated by the LEDs 35 from the circuit board 15 to the central aluminum tube 17 and to the dome for heat transfer and dissipation purposes.

The dome-shaped heat sink 13 further includes a central receptacle or boss 41, which receives the aluminum tube 17. In the illustrative embodiment of FIGS. 1-4, the tube 17 is held in place by a set screw 30 inserted into a threaded hole 32. The hollow center 43 of the tube 17 serves as a wireway to conduct electrical leads into the interior of the heat sink 13 where they may be suitably connected to supply power to the LEDs 35 mounted on the PCB 15. As noted, in one embodiment, the tube 17 serves as an additional heat sink component to assist in dispersing heat generated by the illuminated LEDs 35. While in one embodiment, the tube 17 is aluminum, it may be made of various other metals or materials in other embodiments.

In one embodiment, the lens or lens cover 19 may be convex and formed, for example, of transparent or translucent polycarbonate material. In one embodiment, the lens 19 functions to protect the LEDs but may also serve to contribute to the optical characteristics of the device in other embodiments.

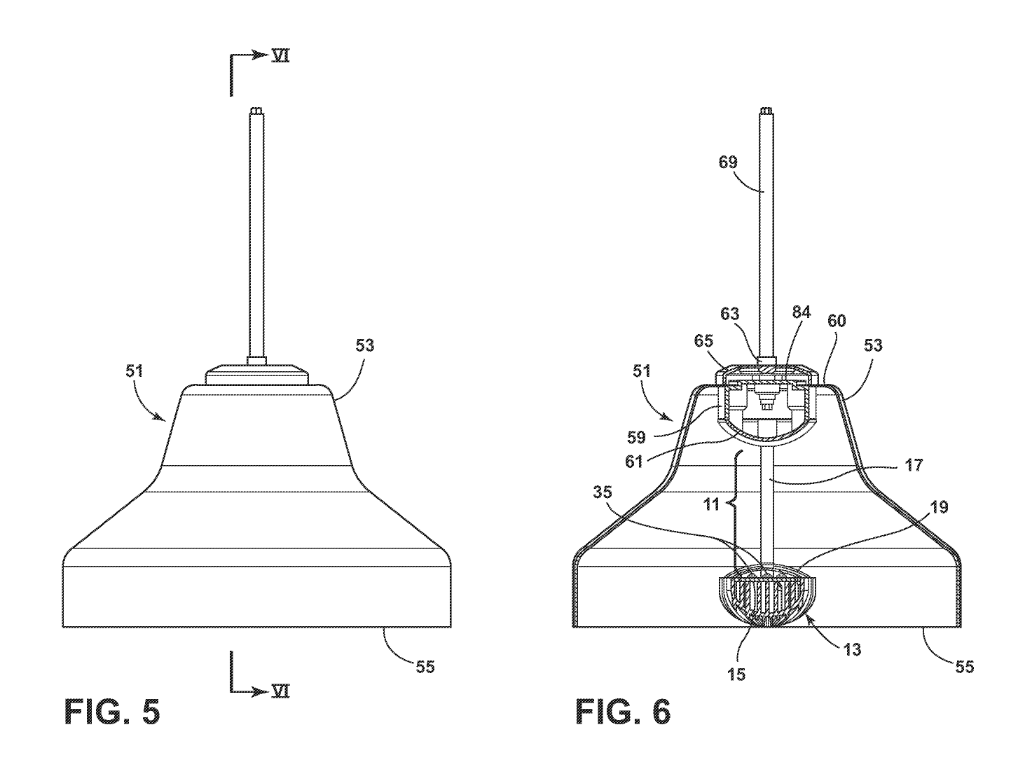

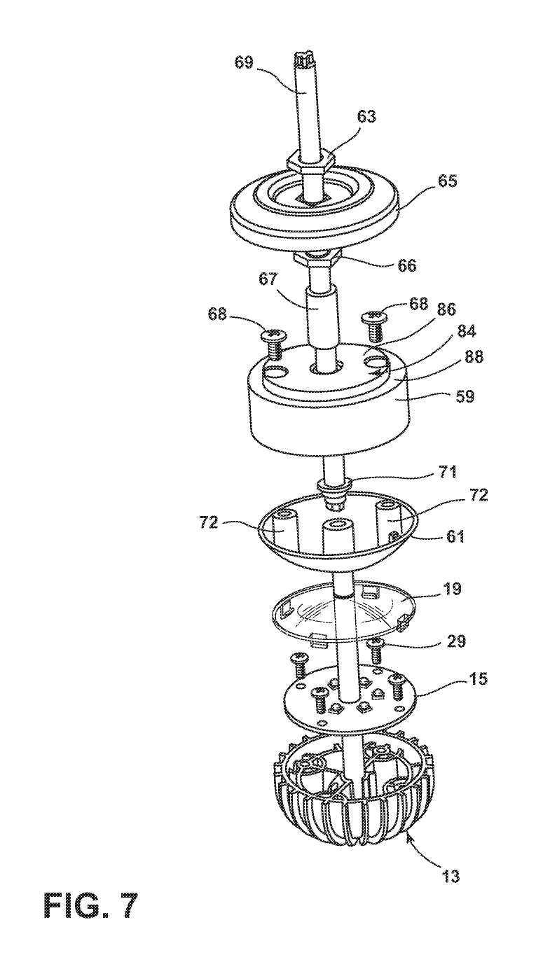

FIGS. 5-6 illustrate an application of the light engine 11 of FIGS. 1-4 in a pendant light 51. The illustrative pendent light 51 embodiment includes a generally bell-shaped lamp shade 53 with the light engine 11 centrally mounted at the lower end 55 thereof.

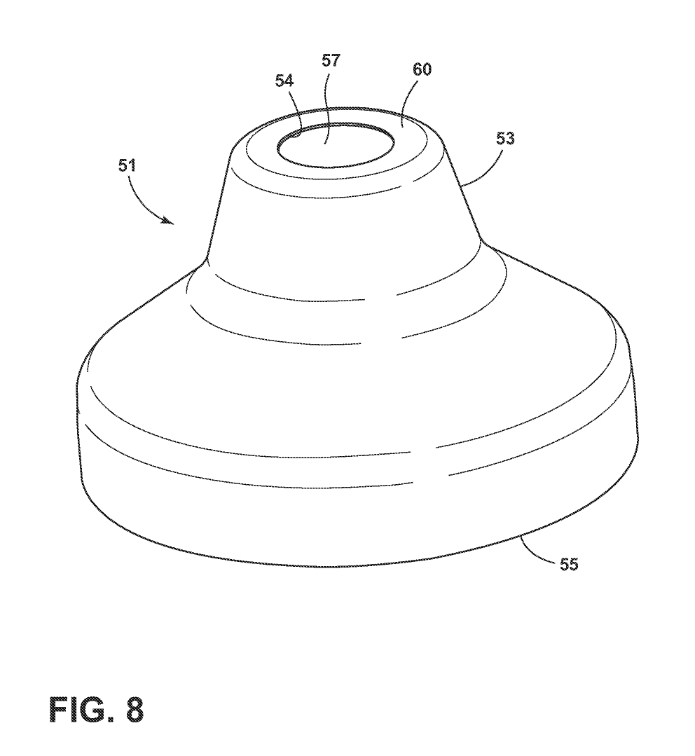

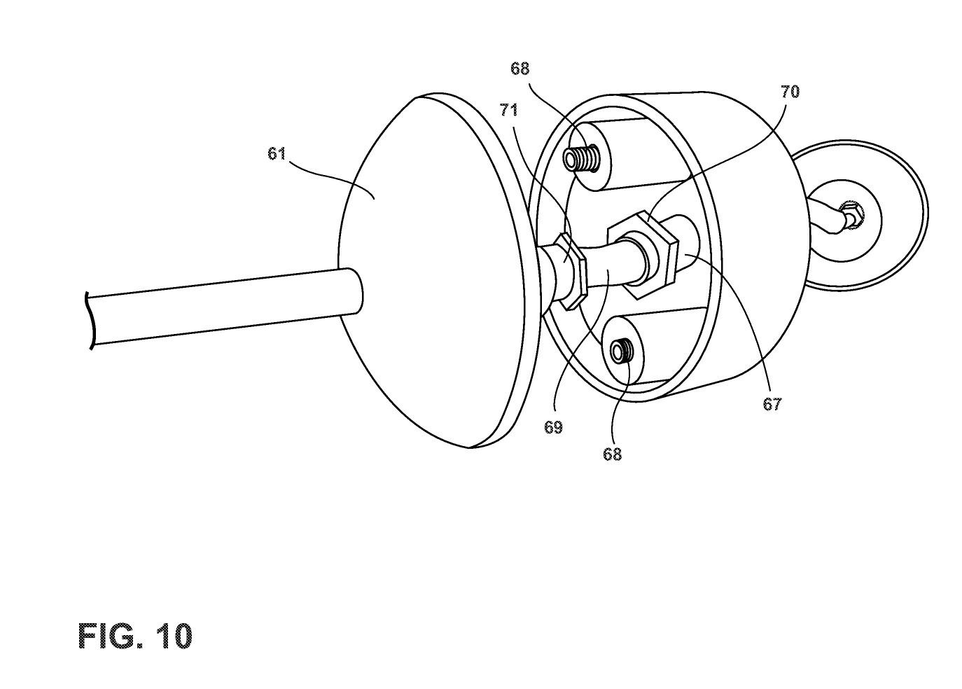

A junction box or “J-Box” cover 59 is mounted in a central circular opening 57 (FIG. 8) in the top 60 of the shade 53 and a J-Box base 61 is positioned adjacent and below the J-Box cover 59 and is attached to the J-Box cover 59 by respective screws 68 threaded into vertical bosses 72. The assembly further includes first, second, and third lock nuts 63, 66 (FIG. 10), a shade cover component 65, a ⅛″ IPS nipple (hollow threaded rod) 67, a power cord 69 and a cord retainer 71.

The shade cover component 65 serves to cover the opening 57 of the shade 53 and, in various embodiments, may be sized to cover various sized legacy openings of various shapes and sizes of conventional shade covers, e.g., in retrofit applications. In some embodiments, a shade cover component 65 may not be needed.

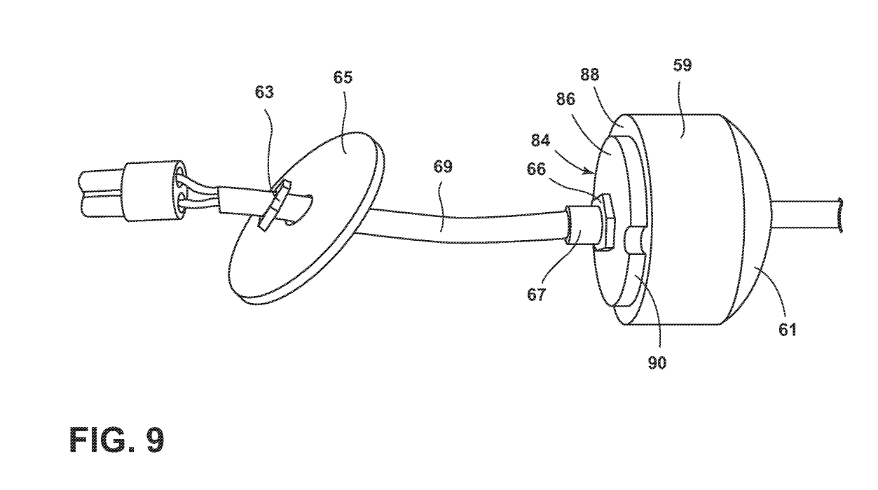

To hold the nipple 67 in place, the second lock nut 66 is threaded onto the nipple 67 against the top surface of the J-Box cover 59, as shown in FIG. 9. The upper end of the J-Box cover 59 has a raised generally cylindrical central portion 84 having a flat top surface 86 and surrounded by a recessed annular rim 88. In the illustrative embodiment, the cylindrical central portion 84 and annular rim 88 are shaped and dimensioned so that the top 60 of the shade 53 fits flushly on the rim 88 of the J-Box cover 59 with its inner edge 54 abutting the vertical periphery 90 of the cylindrical central portion 84 of the J-Box cover 59. Thus, a portion of the top 60 of the shade 53 is sandwiched between the bottom surface of the shade cover 65 and the annular rim 88 of the J-Box cover 59 in an illustrative embodiment.

The cord retainer 71 may be standard off-the-shelf part which crimps onto the power cord 69. The retainer 71 is wider than the opening in the nipple 67 and thereby prevents the cord 69 from being drawn through the nipple 67.

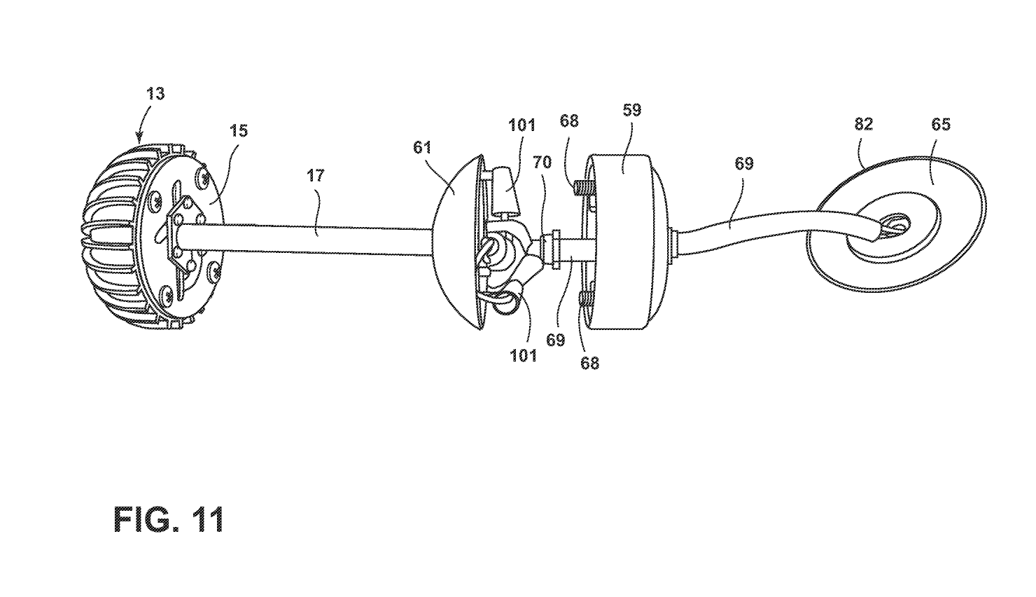

As illustrated in FIG. 11, the J-Box formed by the J-Box cover 59 and J-Box base 61 may enclose connectors 101 which facilitate connecting leads of the power cord 69 to wiring which forms part of the light engine 11 and which conducts electrical power for powering the LEDs 35.

In one embodiment, the LEDs 35 may comprise six (6) Cree XTE model LEDs with a maximum rating of 4½ watts, operating at about 1 watt each. Various other numbers and types of LEDs may be used in various embodiments.

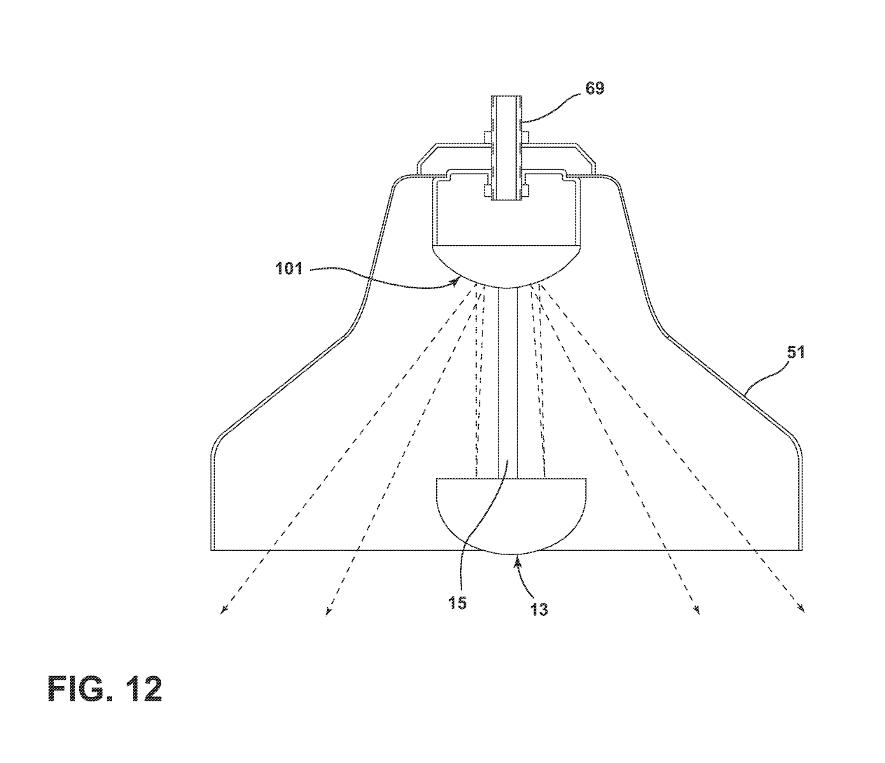

Thus, in the illustrated pendent light embodiment, the light engine is suspended from a junction box located within the lamp shade 51, and an undersurface 101 of the junction box is adapted to receive light transmitted from the LEDs 35 and to reflect all or a portion of that light in a desired or selected manner, one such manner being light rays 103 from the LEDs 35 reflected off the under surface 101, as illustrated in FIG. 12.

A number of variations to the illustrative embodiments described above may be made, for example:
1. The J-Box cover, and particularly the base 61, can have various shapes and/or surface finishes to effect the light reflection out the lighting fixture.
2. The Printed Circuit Board Assembly (PCBA 15) may comprise several sections and also may be mounted at various orientations towards the interior of the shade 53 in order to effect the lighting output of the fixture.
3. The J-Box and dome-shaped heat sink need not always be rigidly attached to each other but rather may be adjustable in angle, length, and/or orientation depending on the application/shade design.
4. The dome-shaped heat sink 13 and associated PCBA 15 could be square, rectangular or other shapes in various embodiments as required, for example, by the design of the shade.
5. The shade 53 shown in the figures is an arbitrary design and could be constructed from a variety of materials including, but not limited to metals, plastics, glass (transparent, semi-opaque or opaque) with or without surface treatments on interior and/or exteriors sides.

Thus, those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A light engine comprising:
a printed circuit board mounting surface mounting one or more LEDs;
a dome-shaped heat sink component having an internal structure for mounting said printed circuit board, the internal structure having a central opening therein, the internal structure further comprising part of a heat transfer mechanism;
a heat conductive tube mounted in said central opening; and
a lens component mounted over the one or more LEDs and having an opening therein through which the heat conductive metal tube protrudes.

2. The light engine of claim 1 wherein said tube is hollow and encloses electrical leads for supplying power to said LEDs.

3. The light engine of claim 1 wherein said tube is formed of metal.

4. The light engine of claim 2 wherein said tube is formed of metal.

5. The light engine of claim 1 wherein said dome-shaped heat sink component is a single unitary component formed of heat conducting material.

6. The light engine of claim 5 wherein said dome-shaped heat sink component has a plurality of heat sink fins formed on an outer surface thereof.

7. The light engine of claim 6 wherein said heat sink fins are disposed generally vertically and descending from a top edge of said component and then curving inwardly toward a central bottom area of said component.

8. The light engine of claim 6 wherein said heat sink component includes a plurality of vertically disposed internal bosses interconnected by a heat conducting web structure.

9. The light engine of claim 8 wherein said web structure comprises a plurality of radially disposed ribs interconnecting said plurality of bosses.

10. The light engine of claim 9 wherein each of said bosses is adapted to receive a fastening device for fastening said printed circuit board to said dome-shaped heat sink component.

11. The light engine of claim 1 wherein said metal tube comprises part of a heat dissipation mechanism.

12. The light engine of claim 10 wherein said dome-shaped heat sink component is formed of aluminum alloy.

13. The light engine of claim 8 wherein said tube comprises part of a heat dissipation mechanism.

14. A pendant light comprising:
a lamp shade having a central opening therein;
a junction box housing positioned within said shade comprising a junction box cover and a junction box base;
wherein the junction box base has an outer surface and a vertically disposed internal boss having an opening therein;
a printed circuit board mounting one or more LEDs;
a dome-shaped heat sink component having an internal mounting structure for mounting said printed circuit board, the internal mounting structure having a central opening therein, the internal mounting structure further comprising part of a heat transfer mechanism;
a heat conductive metal tube mounted in the central opening and removably attached to said dome-shaped heat sink; and
a lens component mounted over said LEDs and having an opening through which said metal tube protrudes;
wherein said metal tube is positioned in the central opening of said boss and is affixed to said junction box base to thereby suspend the dome-shaped heat sink and lens component beneath said junction box housing; and
wherein the outer surface of said junction box base is configured to reflect light from said one or more LEDs in a selected manner.

15. The pendant light of claim 14 further comprising a threaded hollow rod positioned in a central opening of said junction box cover and removably affixed to said cover, said rod providing a passage way for electrical wiring.

16. The pendant light of claim 15 further comprising a lamp shade cover for concealing a top opening in said lamp shade.

17. The pendant light of claim 16 wherein a top surface of said junction box cover is shaped such that a top rim of said shade is sandwiched between a surface of said junction box cover and a surface of said shade cover.

18. The pendant light of claim 17 wherein an upper end of the junction box cover has a raised generally cylindrical central portion having a flat top surface surrounded by a recessed annular rim wherein the cylindrical portion and rim are shaped and dimensioned so that the top rim of the shade fits flushly on the annular rim of the junction box cover with its inner vertical edge adjacent to or abutting the vertical periphery of the cylindrical portion of the junction box cover.

19. The pendant light of claim 15 wherein said threaded hollow rod is affixed to said junction box cover by a lock nut on the outside of said cover.

20. The pendant light of claim 14 wherein electrical leads from a power cord and electrical leads supplying power for said LEDs are interconnected within said junction box housing.

21. The pendant light of claim 14 wherein said junction box cover is removably attached to said junction box base.

22. The pendant light of claim 21 wherein a plurality of screws are employed to removably attach said junction box cover to said junction box base.

23. The pendant light of claim 20 further comprising a cord retainer attached to said power cord within said junction box housing.

24. The pendant light of claim 19 further comprising a lock nut fastened to said hollow threaded rod for retaining said shade cover in position.

25. The pendant light of claim 14 wherein said heat conductive metal tube is attached to said dome-shaped heat sink by a set screw.
